(19) United States
(12) Patent Application Publication
(10) Pub. No.: US 2011/0264551 A1
(43) Pub. Date: Oct. 27, 2011

(54) TRADING AND DISTRIBUTION SYSTEM FOR AUDIO-VIDEO CONTENT

(76) Inventor: Kim Lau, Temple City, CA (US)

(21) Appl. No.: 13/091,958

(22) Filed: Apr. 21, 2011

Related U.S. Application Data
(60) Provisional application No. 61/326,348, filed on Apr. 21, 2010.

(51) Int. Cl. G06Q 30/00

(52) U.S. Cl. 705/26.3

(57) ABSTRACT

Non-exclusive license rights to discrete data products for audio-visual content are licensed to users connecting via a plurality of clients, using a computer. Each of the discrete data products is controlled such that each data product cannot be used to produce audio-visual output for a licensed user until a respective one of release dates defined in a computer memory. In addition, the computer may serve an electronic trading interface to the clients, which is configured to enable any current licensee holding any one of the licenses during a trading period prior to the respective release date for the discrete data product licensed thereby to complete a sale of the any one of the licenses to a participating bidder in an online electronic marketplace publishing current bid prices and ask prices for ones of the licenses offered for sale. The computer may also register successful trades resulting in license transfers.

### CROSS-REFERENCE TO RELATED APPLICATION

This application claims priority pursuant to 35 U.S.C. §119(e) to U.S. provisional application Ser. No. 61/326,348, filed Apr. 21, 2010, which application is specifically incorporated herein, in its entirety, by reference.

### BACKGROUND

1. Field

The present disclosure relates to a trading and distribution system for audio-visual content, in which the audio-visual content is delivered to the consumer by individual electronic transmission to a client device and is organized into individual titles each subject to a release date defined by a content provider.

2. Description of Related Art

Video-On-Demand (VOD) and Electronic Sell-Through (EST) are terms recognized in the art as describing systems and methods for delivering audio-visual content by individual electronic transmission to specified clients in response to specific requests. Although distinctions between VOD and EST may sometimes be blurry, the former generally refers to delivery of content with more limited usage rights than the latter. For example, purchase of a title for a single play on a single client device may be referred to as VOD. In comparison, EST generally refers to electronic content sold with fewer limitations, for example, unlimited playing rights on at least one client device, and sometimes including limited or unlimited playing rights on additional client devices registered under a subscriber account. Content for both VOD and EST delivery may comprise essentially the same electronic content, such as, for example, a motion picture or video program, with the distinctions between the two terms residing in the digital rights management features encapsulating the VOD or EST-delivered content.

Content that is delivered using VOD or EST is often organized into individual titles each subject to a release date defined by a content provider. For example, motion picture titles are often first released for theatrical showings, and months after the theatrical release, are released for distribution via VOD, EST, DVD, Blu-Ray, or other media. The release date is the date on which content first becomes commercially available for sale to the public in its designated medium. For example, the VOD release date for a title is the first date on which a member of the public can play the title received via VOD distribution. The content provider may prevent play prior to the release date by withholding transmission of the title to any public client prior to the release date, or by distributing the title with effective DRM features that prevent it from being played prior to the release date.

Content titles on various media may be sold prior to the scheduled release date, subject to the applicable release date restriction. For example, a title encoded on a Blu-ray media disc may be ordered prior to the release date, and shipped to the ordering customers for delivery on the release date. Content to be delivered using VOD or EST technology has not been considered eligible for pre-release sales, because of the nature of digital distribution. Hence, opportunities for meeting consumer demand in new and innovative ways are not fully realized. It would be desirable to provide innovative systems and methods for managing pre-release sales and use of digitally distributed content having a specified release date, to overcome these and other limitations of the prior art.

### SUMMARY

The present technology enables, among other things, pre-release purchasing of content for VOD and EST delivery, with restrictions placed on use of the pre-release content, and other improvements utilizing new and different characteristics of electronic delivery as compared to disc media distribution. For example, VOD or EST delivery of pre-release content to the pre-release customers may be delayed until the disc media release date, or until a definite date in advance of the disc media release date. In addition, the technology provides a trading platform through which pre-release customers may sell their ownership interests in pre-release content to other members of the public, and prospective buyers may purchase ownership interests offered for sale by earlier purchasers. The VOD/EST trading platform may be operated on one or more content servers under the control of a content provider, sometimes generally referred to herein as a “VOD distribution host,” in response to input from distributed client devices.

The VOD distribution host may be configured to sell, set prices for, and facilitate trading of ownership interests in pre-release copies for VOD or EST distribution to members of the public that connect to the host using respective client devices. The host may define a limitation on a number of copies of each content title in which pre-release ownership interests will be sold, organized into one or more tranches. For example, for a particular title having a media disc release date of January 25^{th}, the host may make available a limited number of copies for VOD delivery and play on January 23^{rd}, a second limited number of copies for VOD delivery and play on January 24^{th}, and a third limited number of copies for VOD delivery and play on January 25^{th}. Continuing the example, the host may sell an unrestricted number of copies for VOD delivery and sale after a certain date, for example, January 26^{th} or later. To enforce the numeric limitations on VOD or EST delivery of pre-release versions, the VOD host may track the number of sales made in each tranche and cease selling copies when the limit has been reached for each tranche.

In addition to defining numeric limitations for pre-release copies, the VOD host may implement a dynamic pricing strategy in which the current price is adjusted in response to demand feedback. After setting an initial price based on anticipated demand, the host may increase or decrease the initial price in response to demand as measured by, for example, a rolling average sales rate, adjusted for time-of-day. In addition, or in the alternative, the host may adjust the price in inverse relation to the number of copies left for sale divided by the amount of time until sales are closed. Thus, as the “supply” of copies sells out, the host may increase the price and conversely, if excess supply is detected the host may lower the price until the tranche sells out. The host may continue selling until the number of copies allotted to the tranche sells out, or until a pre-determined cut-off time such as, for example, the playable date for the VOD content or some date in advance of the playable date. Sales price adjustments may be made by the VOD host using computer hardware and software programmed to adjust a current selling price using a predetermined algorithm responsive to sales data, time, and optionally additional static or dynamic parameters and variables.

In addition, after the sale of each tranche for a given title is completed and prior to the scheduled play date for that title & tranche, the VOD host may provide an on-line automated trading system in which holders of ownership interests in the individual VOD copies may sell their interests to other users, in exchange for cash or credits towards future purchases. The trading system may resemble automated electronic trading for securities, in that the host may enable owners to submit buy and sell orders for each title and tranche, specifying, for example, a limit order, a market order, or a stop loss order. The host thereby may match buyers and sellers and clear trades using an internal bookkeeping system and optionally, a link to an external payment processing site, such as, for example, Paypal®. When the VOD copy “matures,” i.e., reaches its specified play date, the VOD host may cease trading in the copy and allow the current holder to download the proper encrypted video file with an authorized DRM license as specified in the original contract of sale. Optionally, if during the trading period the host detects a lack of sell orders, the host may sell original VOD/EST copies through the trading system, either enlarging the size of the tranche or decrementing a sales reserve limited to a fixed number, by placing sell orders at or just above the current highest buy orders. Conversely, if during the trading period the host detects a lack of sellers, the host may buy VOD/EST copies offered for sale through the trading system, either reducing the size of the tranche or incrementing a sales reserve for each purchased copy, by placing buy orders at or just below the current lowest sell orders.

The host may provide additional functions for subscribers, for example, tracking and reporting on each user's past and pending purchases, trades, and downloads, as part of a customer service function responsive to user requests. In addition, the host may track and report on sales and trading activity in relation to various types of demographic data, for use in marketing and business planning.

A more complete understanding of the trading and distribution system for audio-video content will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 is a block diagram showing elements of a computer system for trading and distributing audio-video content, and ancillary devices or components.

FIG. 2 is a functional block diagram showing relationships between different functional elements of the trading and distribution system.

FIG. 3 is a chart showing an example of dynamic pricing in relation to time and sales.

FIG. 4 is a flow chart showing an example of a method for dynamic pricing for a VOD or EST title during a pre-release period.

FIG. 5 is a chart comparing timelines for different tranches of an audio-video title, as an example that may be implemented for pre-release trading.

FIG. 6 is a flow chart showing an example of a method for facilitating trading of a VOD or EST title during a pre-release period.

FIG. 7 is a flow chart showing an example of a method for trading and distributing audio-visual content.

FIG. 8 is a flow chart showing an example of a method for managing transfer of licenses granting rights to access audio-video output from a discrete data product.

FIG. 9 is a block diagram showing an example of an apparatus for performing the method of FIG. 8.

### DETAILED DESCRIPTION

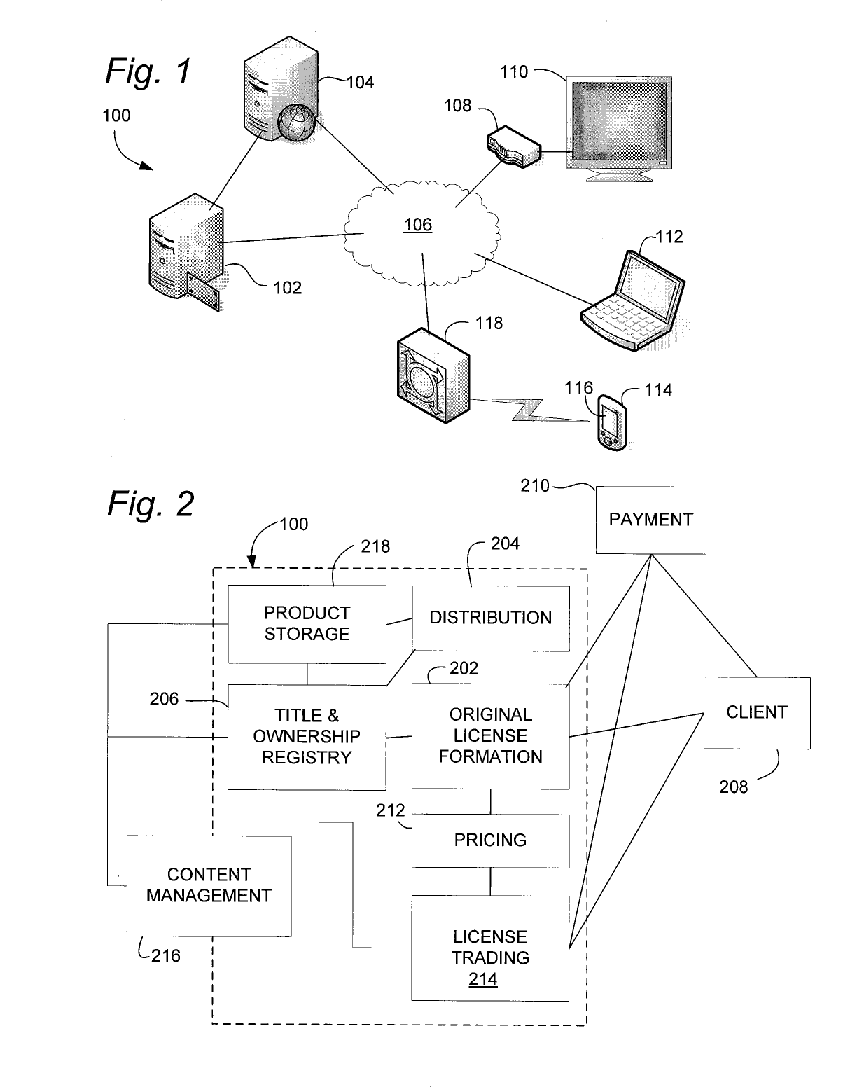

A trading and distribution system for audio-video content may be provided by developing software or other operating instructions, and configuring hardware, in accordance with the detailed description that follows and the summary above. FIG. 1 shows elements of a computer system 100 for trading and distributing audio-video content, and ancillary devices or components. System 100 may comprise one or more computer servers, for example, a commerce server 102 configured for licensing and trading of VOD or EST viewing rights, and a data distribution server 104 configured for holding and serving copies of VOD or EST content, and serving such content to various clients under control of the commerce server.

VOD or EST content is configured as individual discrete data products, for example, a motion picture title or dramatic serial episode, electronically packaged with DRM controls as known in the art and any accompanying audio-video content, for example, trailers for coming attractions and so forth. Each discrete data product may be produced via an editing and production process with a resulting distribution master copy held in a memory of (or in communication with) the secure distribution server 104. Each discrete data product is associated with a defined release date in the memory of file server 104 and/or in another computer controlling the distribution of information from the file server. In some embodiments, the file server may be configured such that it does not transmit any copy of a distribution master copy prior to its associated release date. In the alternative, or in addition, the release date may be encoded as part of DRM controls in the distribution master copy, preventing clients from playing any copy of the master prior to the encoded release date.

The distribution server 104 may transmit copies of discrete digital data products to one or more destination client selected by the VOD or EST licensees for each product, via a wide area network 106, for example, the Internet. Suitable clients for receiving data products may include, for example, a set-top receiver 108 configured to provide a video signal to one or more display devices 110, for example, an LCD, gas plasma, or projection television or display monitor. Other suitable clients may include, for example, a personal computer 112 or a mobile communications device 114 with a display screen 116 connected via a wireless network (not shown) and communications gateway 118 to network 106. Licensees may be identified entities registered with the commerce server 102 and associated with account records indicating one or more preferred destination clients. In response to a signal from the commerce server indicating that transmission of a particular digital data product is authorized for a particular licensee, the distribution server may determine the appropriate file format in response to information identifying the licensee's preferred client, and cause the data product to be transmitted to the preferred client.

The commerce server 102, when suitably configured using software and hardware, may function as an electronic licensing means for granting non-exclusive license rights to use the discrete data products distributed by the distribution server 104 to various clients. As noted above, each of the discrete data products to be licensed using the commerce server is recorded in a digital medium, is configured for providing audio-video output and is controlled such that each data product cannot be used to produce audio-visual output for licensees until a respective one of release dates defined in a computer memory for each respective data product.

Each server 102, 104 may comprise one or more processors, processor volatile memory, non-volatile memory, internal communication busses, network interfaces, input and output devices, and other components as known in the art. Generally described, a server may be configured to perform the functions described herein by providing software and/or firmware with encoded instructions. When loaded into processor memory, the encoded instructions cause the server to perform the functions described herein. Suitable methods for configuring a computer server using software or firmware to function as described herein should be apparent to one of ordinary skill, using the present specification as a guide.

Different functional elements of the trading and distribution system 100 and relationships between the elements are diagrammed in FIG. 2. An electronic licensing means is shown in FIG. 2 as functional block 202. This element may be coded using one or more program modules, that when operated by the commerce server 102, cause the server to serve an interactive electronic licensing interface, such as an interactive web page, to participating clients, for example, client 208.

The commerce server may enable users to select one or more discrete data products desired for licensing from a set of available products accessible through the licensing interface. The commerce server may generate licenses in response to client data for selected products obtained via the electronic interface. The electronic interface may describe defined license terms such as price, product title, description, release date, and any applicable restrictions on use such as, for example, a maximum number of times the product may be played or a maximum number of devices on which the product may be played. The electronic licensing interface may be configured to enable client input indicating acceptance of license terms and authorization for payment. In response to receiving acceptance of license terms and confirmation of payment, the commerce server may cause a license registry 206 to be updated with information recording an identifier for the licensed product (e.g., title and release date) and an identifier for the licensee. Complete licensee and product data may be maintained in other data tables as known in the art, accessible using the identifiers in the registry.

Payment may be accomplished using a suitable method known in the art for remote payment, for example, a credit card, debit card, electronic check, electronic cash, or third-party payment processor such as, for example, Paypal® or the like. The licensing module 202 may communicate with payment processor 210 to initiate a transaction and confirm that payment has been completed.

Each record in the active registry should indicate a release date and time prior to the current date and time. In other words, the registry 206 records are concerned with licensee rights to use content in the future. Once the release date is reached, the licensee's rights mature, meaning that the licensee of record as of the maturation time and date receives the use rights provided by the license, and these rights are enabled by electronic distribution and/or unlocking of distributed content using a DRM module in distributed content. After maturation of the rights, the associated records in the registry are no longer of current interest in system 100, and may be deleted from the registry 206, or archived for recordkeeping purposes. Archived records may be used to generate reports of user licensing and trading activities for customer service and other purposes.

A licensing statistics and pricing module 212 or other computing means may be implemented in the commerce server or in another computer, in communication with the electronic licensing module 202. Among other things, module 212 may track and record statistics for the licensing module 202 and trading module 214. Such statistics may include, for example, a cumulative count of licenses granted for each of the discrete data products prior to their respective release dates, a rate of licenses granted per unit time, trading price and volume, and other statistics as known for sales and trading transactions. System 100 may use statistical data from module 212 to provide dynamic pricing of licenses during a portion or all of the licensing period for each product. Specifically, module 212 may compute a current optimal license price during the licensing period using a pricing algorithm responsive to statistical data from licensing or trading activity. Examples of pricing algorithms are provided later in the specification. Periodically, or in response to specific events, the pricing module 212 may provide the currently computed optimal price to the license module 202, which may initiate current licensing offers at the current optimal price.

System 100 should be configured to operate so that each discrete data product is the subject of distinct activity during distinct periods. A pre-licensing period may be defined by an absence of licensing or trading in licensing rights. A licensing period follows the pre-licensing period, and is defined as the period during which the licensing module 202 is operative to form new licenses to use the data product. A trading period may begin at any time after the licensing period begins, or after the licensing period terminates. During the trading period, the trading module 214 is active and enables trading of licenses recorded in the registry 206, in response to client input. Both the licensing period and the trading period terminate before the release date and time, but not necessarily at the same time. The use period begins at the release date and time, and is defined by the period in which use of the distributed data products is enabled in accordance with license terms. During the use period, system 100 does not enable any licensing or trading of the data product. Each of these periods may be implemented and caused by operation of the various modules of system 100 and related tools, such as DRM tools, as described herein.

A license trading module 214 implemented in the commerce server may provide electronic trading means in communication with the licensing statistics and pricing module 212. The trading module enables any current licensee holding any one of the licenses during its trading period to complete a transfer of the license to a participating bidder in an online electronic marketplace. Among other things, the electronic marketplace publishes current bid and ask prices for ones of the licenses offered for sale, using an electronic interface, such as an automatically updating web page responsive to a bid database. The trading module 214 may also register a sale when a bid price for a license equals an ask price, and facilitate payment from the buyer to the seller via a payment processor 210.

For example, the license trading module may enable a user, via a connected client, to provide input indicating a desire to trade a data product to which the user holds a license, via one or more web pages or other electronic interface. In response to the input, the trading module may confirm that the user holds a license to the selected product and enter a selling bid on the user's behalf in a bid database of the trading market for the selected data product. Similar to securities trading, the trading module may, in response to selection input from the client, enter the trade as a “market,” “limit,” “stop” or other order as known in the art of securities trading. Similarly, the module may accept and post buying bids from other identified users, settle trades in which selling and buying bids agree, and provide updated licensee identifiers to the registry module 206 reflection the outcome of a trade. Other examples of operation of the trading module are provided later in the specification, in connection with FIG. 6.

Providing and managing of the data products may be handled via an external content management function 216. An authorized administrator may provide a master distribution copy of each data product to a product storage module 218 of system 100. Each master distribution data may be associated with a release date and time and other licensing and trading parameters defined in advance for the data product. In the alternative, or in addition, some or all of theses parameters may be determined by default values built into different modules of system 100. Licensing parameters may include, for example, a start date and time for the trading period, a fixed number of licenses available, an initial price for licensing, a selected pricing algorithm (either fixed or dynamic), duration of the licensing period, and other details. Trading parameters may include, for example, a start time and date for the trading period, duration of the trading period, an indication of whether administrative bidding is permitted during trading, and if so, applicable limits and procedures for administrative bidding. These parameters, to the extent customized for a particular data product and not default values, may be stored in a file or database of the product storage module 218, in association with the data product to which the parameters are to be applied.

The distribution module 204 performs the distribution functions of the distribution server 104, described in connection with FIG. 1 above. Distribution of each data product may be triggered when the current time and date as determined by an internal clock/calendar equals the release date/time defined for the product. At that point, the distribution module may, in response to clock data and parameter settings, distribute copies of the data product to clients in accordance with the most current records in the ownership (licensee) registry 206.

The system 100 may use dynamic pricing of licenses to maximize revenue from licensing a fixed or variable number of licenses to use discrete digital content at some future time. Conceptually, an optimal price over time for a closed, limited system is that p(t) (time-varying price) that results in the maximum of the integral sum of p(t)·u, where u represents units sold and varies inversely with price by the law of supply and demand. A product licensed subject to a definite future release date is an example to a closed limited system, because all licenses are executed within a definite licensing period. The number of licenses available within the period may also be arbitrarily fixed. Although digital content in the VOD/EST context is theoretically unlimited in supply, demand is not and varies in some inverse relationship to price: there is less demand at higher prices than lower. Demand for discrete content usually varies with time, diminishing as content ages. The relationship between time and demand can sometimes invert, however, as when the popularity of content increases by word of mouth. Special considerations may apply in systems, such as those described herein, in which content is licensed for use at some future time. Earlier licensees do not enjoy the benefit of earlier use, and this may flatten the demand curve with respect to time. Conversely, a perceived shortage in the number of licenses made available may steepen the demand curve, particularly for special limited early releases. Demand may also vary as a factor of time-of-day, or in response to external factors such as marketing. To summarize, demand varies in response to time and other factors, and therefore revenue for a fixed number of units or limited transaction period may be optimized using dynamic pricing.

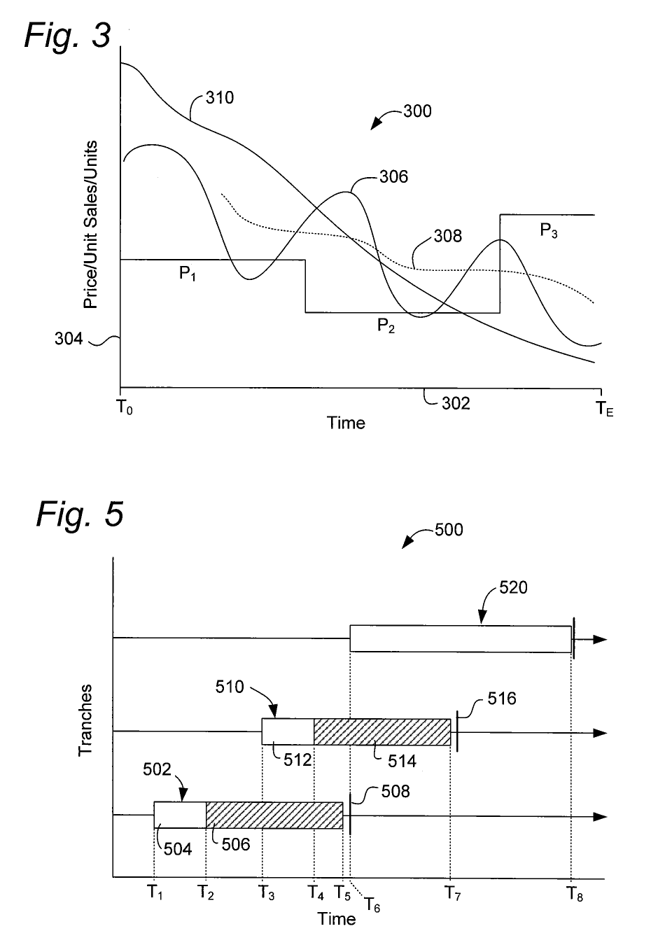

FIG. 3 is a chart 300 showing a simplified, hypothetical example of dynamic pricing in relation to time and sales, such as may be implemented using a pricing module 212 for a license to a data product having a future release date. Time in arbitrary units is shown along the horizontal axis and price, unit sales, and units in reserve, respectively, on the vertical axis 304. A licensing period for a specific product begins at time T₀ and ends at time T_{E}. The release date (not shown) would appear somewhere to the right of T_{E}, off the figure. Unit sales line 306 represents completed licenses per unit time as completed by the licensing module. Line 306 exhibits a daily sinusoidal cycle related to time-of-day and a gradual decline. Dashed line 308 represents a cumulative running average of unit sales, smoothing daily variations in licensing rate. The reserve line 310 represents the number of remaining licenses available for license, assuming total available numbers are fixed to a selected number. The line shows a continuous depletion in unit reserves, although the reserves are not fully depleted in this example. Dynamic price line 312 represents an example of price changes during the licensing period, responsive to both average rate of sales 308 and reserves 310. Pricing is initially fixed at price P₁. In response to diminishing average demand and detecting a substantial remaining reserve, the price is reduced to P₂. Later, in response to relatively steady demand and diminishing reserve, price is increased to P₃. The licensing period ends at the final price P₃ with a small reserve, about 10% of originally available licenses. FIG. 3 merely provides an example of dynamic pricing in response to rate of sales and reserves, and is not meant to limit implementation or suggest an optimal solution. Different objectives and circumstances will call for different approaches.

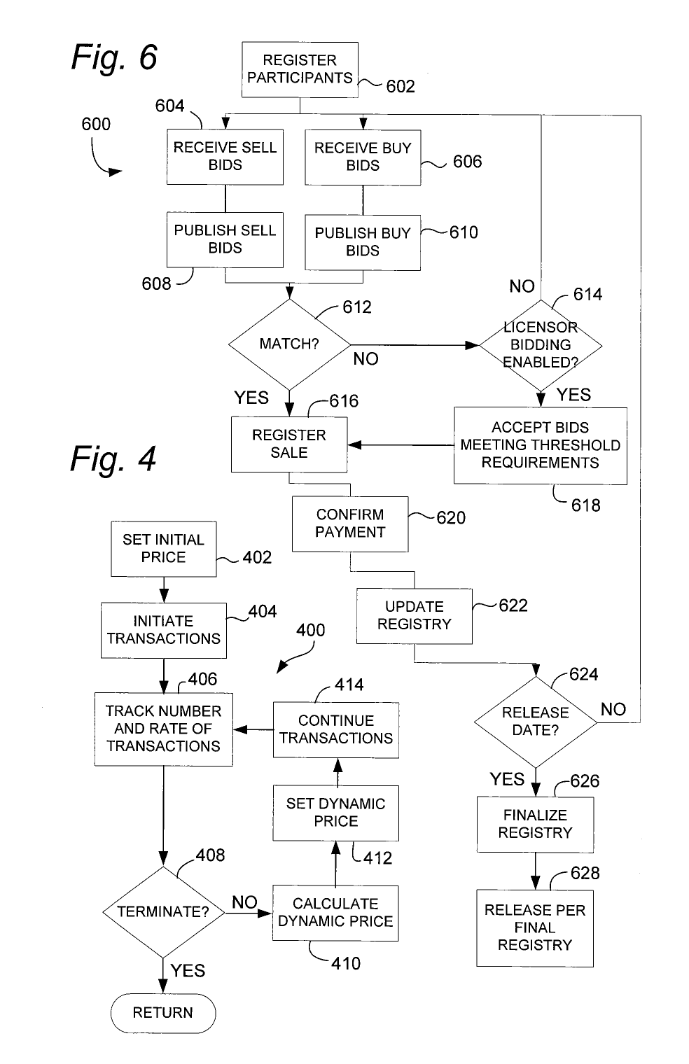

FIG. 4 shows an example of a method 400 for dynamic pricing for a VOD or EST title during a pre-release period, as may be implemented in system 100. An initial price may be set 402 using a default value for system 100 or a special initial price specified by licensing parameters for the digital product being licensed. Similarly, an initial reserve number may be established by default or set by an associated license parameter. At 404, the licensing module initiates licensing transactions 404 at the initial price, using an electronic interface such as a web site. If applicable, the initial number of licenses to be made available may be published using the interface. For example, a limited early VOD release of a popular motion picture may report some fixed number of licenses available, and may similar publish decreases in remain reserve as the licensing period progresses.

At 406, the system tracks total licenses and rate-of-sales. As each license is confirmed and recorded, the licensing module may provide a signal to the tracking module 212, which may increment a register counting the number of licenses granted since the beginning of the license period, and accumulate counts for fixed periods, for example, licenses per second or per minute. These rate measurements may be recorded. The tracking module may also decrement a variable representing the number of licenses remaining in reserve. These and other measures may be placed in a computer memory for future reporting or for use in computing a dynamic price.

Tracking and recording licensing statistics may continue until the licensing period ends 408. The licensing period may end when a specified end time/date is reached, or when (if applicable) a specified fixed number of licenses are completed, that is, a fixed reserve is depleted. Prior to termination, the pricing module calculates a price 410 based on available tracking statistics. Calculation 410 may be performed at specific intervals of time, for example, every five minutes, or at specific sales intervals, for examples, every time licenses in an additional amount equal to 1% of the initial reserve are completed. In one embodiment, the module may use a control algorithm designed to ensure that the reserve is depleted, or reaches a specific number, at the end of a specific period, using current rate-of-sales and its time derivative to project total licenses to be completed in the remaining time. If projected total licenses are less than a target amount, the algorithm decrements the price in an amount proportional to the projected shortfall. If projected total licenses are greater than a target amount, the algorithm increments the price in proportion to the projected excess. A mathematical formula may be used to project future sales from past selling pattern, using a linear or non-linear projection. Projections necessarily involve assumptions about future demand behavior, which assumptions can be refined based on experience. Dynamic pricing of licenses to VOD/EST products with future release dates is not known in the art, and therefore such experience awaits implementation of the present ideas in a real market.

The new price is provided to the licensing module, which adopts the price for subsequent license offers 412. Licensing continues at the new price 414 with statistical tracking 406 at specified intervals, until termination of the licensing period.

A specific data product, such as an audio-video title, may be licensed in separate tranches, with each tranche having a different release date. Such separation may permit more efficient price segregation, as a tranche having an earlier release date may be perceived as significantly more valuable than a tranche having a later release date, but only for a relatively limited subset of potential consumers. To better illustrate implementation of tranches, FIG. 5 shows timelines 500 for different tranches of an audio-video title, as an example that may be implemented for pre-release trading. In this example, relative timing of different events is merely hypothetical and not meant to suggest an optimal arrangement. As licensing and trading of VOD pre-release tranches has not yet been done in practice, there is presently no empirical basis for determining optimal timing.

A first tranche 502 may be assigned a licensing period 504 beginning at time T₁. Tranche 502 has an assigned release date/time 508 at time T₆. The licensing period may continue until a later time T₂, at which time a trading period 506 is initiated. The trading period 506 may continue until time T₅, just prior to the specified release date at time T₆. A licensing period 512 for a second tranche 510 licensing the same audio-video content as first tranche 502, but having an assigned release date/time 516 just after time T₇, may be initiated at a time T₃ midway between the times T₂ and T₅. The licensing period 512 for the second tranche may end, and its trading period 514 begin, at time T₄ between times T₃ and T₅. The trading period for the second tranche may end at time T₇ just before its release date/time 516. Meanwhile, a non-tradable tranche 520 may begin sales at some intermediate time T₆, and continue sales up until and after its release date at the last shown time T₈. Tranche 520 may represent sales for a non-VOD/EST release, for example, a release on a tangible medium (such as on an optical disc) having a first ship date at T₈. Tranches may be arranged and timed so as to provide timed distribution in stages well-calibrated to anticipated demand. More highly anticipated releases may support more numerous tranches than less highly anticipated releases. A licensing period need not end on or before the trading period for the same tranche; rather, it may be possible or desirable to permit some degree of overlap between these periods.

Whether or not organized into more than one tranche, each release of a VOD or EST title may be traded by licensees and prospective licensees beginning at some time after the licensing period has started and ending before or on the release date. FIG. 6 shows an example of a method 600 for facilitating trading of a VOD or EST title during a pre-release period, as may be implemented using system 100. Essentially, trading mechanics may resemble known electronic trading systems for intangible financial assets, but include modified and novel elements relating to the new type of asset traded. The novel relationships to licensing and distribution of the unique media asset, as have already been described, vest the trading with economic significance. Details of a trading method are shown to exemplify a programmed embodiment of the described trading module 214. The method assumes a particular discrete data product has first been defined and registered as previously described, and is ready for trading.

Initially participants in the marketplace are registered 602. The commerce server may be configured to serve a trading interface only to clients operated by registered members with associated payment account information and client addresses. Identity may be confirmed using any suitable authentication system, such as, for example, login and password. To initiate trading at the beginning of a trading period, the commerce server may activate a link on a home page to a trade selection page for the data product to be traded. The trade selection page enables each user to select one or more copies of the data product registered as licensed to her in a preceding licensing period. For example, the trade selection page may display a list of all titles licensed to the registered user, in which those titles for which a trading period is active are highlighted and configured to operate as links. In response to user selection of a highlighted link, the commerce server may cause a trade entry web page to be transmitted to the user's client device comprising an input form for the user to enter a selling bid price or otherwise define a “sell” order (e.g., by placing a sell at the “market price” order). The trade entry page may display other information also, such as a description of the title to be sold and a chart showing the current selling price and historical price of at which past trades were executed. After entering and confirming the order at the client, the client in response to user input transmits the sell order to the commerce server, which receives it at 604. Bid instructions may include instructions to cancel or change existing bids, in addition to placing new bids.

In parallel to sell order entry and receipt, the commerce server may receive buy orders 606 using a complementary communication and order entry process. For example, the commerce server may maintain a trading home page listing all data products currently trading, and serve the trading home page in response to requests from connected client devices for registered users. Users may select data products of interest from the trading home page, for example by selecting a link that generates an HTML request for an associated trade selection page. The commerce server may serve a trade entry page for the selected data product, which may contain the same or similar information as the trade entry page for bidding sellers. In addition, the trade entry page may include a form or other interactive object by which users may enter an order to buy license rights to a data product, or to change or cancel an existing bid placed by the user. After entering and confirming the order at the client, the client in response to user input transmits the buy order to the commerce server, which receives it at 606.

In response to receiving sell and buy bids 604, 606, the commerce server updates its bid database and publishes the current bids 608, 610 in trade entry pages or similar electronic publication. Further when the commerce system determines that a current sell bid equals a current buy bid 612, it registers a sale from the user placing the sell bid to the user placing the matching buy bid, for example by updating a “pending transfers” data table to include the price, seller & buyer identities of the matching bidders, data product identifier and transaction date/time. Concurrently, the commerce server may update its current bid database to remove the matching bids or flag them as inactive pending transfers. In the transaction context, a matching bid is a sell bid at a price equal to or less than the price of an active buy bid (in which case the transaction may be executed at the sell bid price or at the buy bid price, depending market rules), or a buy bid with a price equal to or greater than the price of an active sell bid (market rules again determining which bid price prevails). Frequently, the number of matching bids will not be equal, for example, there may be more than one buy bid matching an available selling bid. In this case, the commerce server may be configured to select the highest buy bid, or, if there is more than one bid at the highest price, randomly select one of the highest buy bids. Conversely, if there is more than one sell bid matching an available buy bid, the commerce server may select the lowest sell bid or randomly select one of the lowest sell bids.

If there are no matching bids 612, the commerce server may determine whether bidding is enabled for the licensor 614. Whether or not licensor bidding is enabled may depend on various factors or combination of parameters determined for the particular market, or may simply be forbidden under any circumstances. When permitted under some circumstances, these parameters may include, for example: the length of time a bid goes unmatched; the relative amount of price difference between the lowest sell bid and the highest buy bid; length of time left in the trading period; average trading volume; amount of reserve licenses held by the licensor; whether or not an unmatched sell bid is less than a specified ceiling threshold; and whether or not an unmatched buy bid greater than a specified floor threshold. If the commerce server determines that licensor bidding is not permitted, trading continues without licensor bids at 604, 606.

If by applying predefined parameters the commerce server determines that a licensor bid is permitted, the commerce server accepts sell or buy bids meeting threshold requirements 618. For example, the server may accept sell bids that are less than or equal to a predefined ceiling defined by the licensor. A licensor may define a ceiling for matching unmet sell bids. A ceiling at or near the lowest price offered during the licensing period may help ensure that users are not stuck with viewing rights to content that is no longer of interest to them, which may discourage future buying or trading interest. In practice this may work similarly to a refund, which may be either of the full purchase price, or some lesser amount, but operates in a more sophisticated manner especially when initial licensing is done using dynamic pricing. Conversely, a licensor may also sell into a market to generate extra revenue, in case reasonable buy offers are going unmet. For example, the licensor may elect to sell additional VOD rights into a market when buy offers exceed the highest price available during the initial licensing period and are not being matched by non-licensor sell bids within a defined minimum response period.

Licensor bids, although generated internally by operation of software implementing decision parameters and not made in response to user input via connected clients, may be recorded in the pending sales registry 616 in a manner similar to user bids. In the event that the licensor is selling a new (non-reserve) license that is not recorded in the ownership registry 206 (FIG. 2), this fact should be noted in the pending sales registry so that once the sale is confirmed, the sale can be added to the ownership record as a new license, and not an ownership change to an existing license.

The commerce server may continuously operate to confirm payment 620 for transactions pending in the pending sales registry. Depending on capital reserve requirements for eligible bidders, there may be almost no possibility of shortfall in funds available, in which case payment confirmation may be skipped. If some possibility of payment shortfall is possible, confirmation that funds are available and reserved for the sale should be received electronically from the payment processor for the buyer before the sale is confirmed. If the sale cannot be confirmed within a defined period of time after the trade is made, the trade may be canceled by the commerce server with electronic notice to the participants. Sell bids may then be automatically re-entered by the commerce server in the bid database for the trading session, to thereby reappear in the trade entry pages, or may be re-entered only after receiving user confirmation, depending on preference settings for the seller.

In response to receiving a signal confirming payment, the commerce server may update the master ownership record in the ownership registry 622 to reflect the trade outcome. The traded license will then be recorded as held by the user that placed the selected matching bid. This new owner, just like the previous owner, as the holder of record may elect to hold the license rights until the release date to view the licensed content, or may elect to resell the rights either for profit or just to recover costs in the event of a change in the new owner's entertainment plans.

The trading may continue during the trading period until the termination of trading, which should generally be closely linked to the release date. For example, trading may be permitted until 12:01 am Greenwich time on the release date, or other point in time. At termination of the trading period 624, the commerce server may provide a signal causing the ownership registry to be finalized 626, meaning no further changes are permitted. In addition, the commerce server may provide a signal to a distribution component of the system, such as the distribution server, which in response may commence to distribute copies of the digital product to client addresses designated by the current owner. In the alternative, or in addition, the distribution server or other system component may transmit a signal to distributed copies of the digital product to unlock DRM controls that would otherwise prevent use thereof.

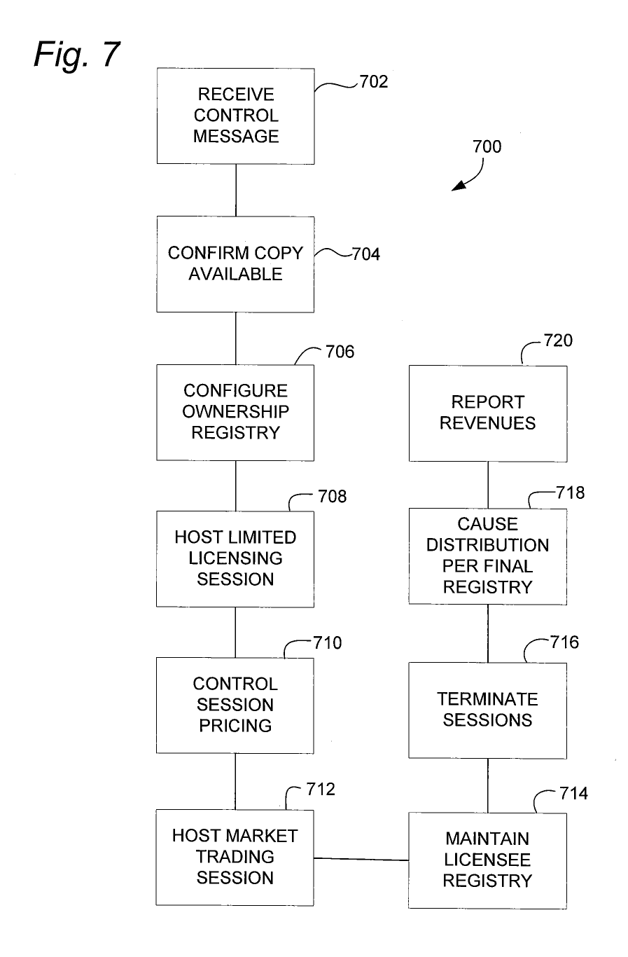

In summary of the foregoing, a transaction engine programmed and operating in one or more computers may perform a method 700 of distributing audio-video content, as shown in FIG. 7. A first step 702 may include receiving a control message identifying at least a digital audio-visual work and a future release date, a maximum number of licenses permitted for the release date, and optionally other parameters as discussed above. At an appropriate time prior to the release date, the transaction engine may confirm 704 that a master distribution copy of the identified audio-visual work is stored in a computer memory for distribution to remote clients via a distribution node. In response to the control message, the transaction engine may configure a licensee registry for the identified digital audio-visual work and associated release date 706. The transaction engine may also host an e-commerce licensing session 708 in which licenses to use the digital work after the release date are granted to identified users in response to client input, but not exceeding the defined number of available licenses in total. The licensing session may have a defined beginning and end time defined by the control message, by default parameters of the transaction engine, or by some other control method, but in any case both occurring prior to the release date. License prices during the licensing session may be controlled 710 by the transaction engine to either be static or dynamic, with values determined by the control message, an internal algorithm and parameters of the transaction engine, or by some combination of these or other control methods.

Beginning at some time after commencing the licensing session, and prior to the release date, the transaction engine may host an online trading session 712 in which licensees of record may trade their registered license rights to other users for monetary payment, in accordance with defined market rules resulting in market price discovery responsive to supply and demand. The transaction engine may ensure that the licensee registry is updated 714 to reflect outcomes of the trading session and licensing session. The transaction engine may terminate the trading session 716 at any defined time prior to the release date and preferably after termination of the licensing session. In response to the release date, the transaction engine may cause distribution 718 of the audio-video work according to the licensee registry, or otherwise cause enablement of use of the audio-video work only on or to designated clients specified by the license holders recorded in the final registry at the termination of the trading session. Thus, as a result of operation of the transaction engine, the audio-video content is output by the designated client devices operated by the license holders on or after the release date, where the identity of the license holders in determined by the transaction engine during the preceding licensing and trading sessions. In addition, the licensing and trading sessions controlled by the transaction engine cause licensing and trading revenues to be realized by the licensor or provider of the audio-video content and by users that participate in trading as sellers prior to the release date, when the audio-video content is not usable by its registered licensees. These revenues may be reported by the transaction engine 720 during or after the licensing and trading session.

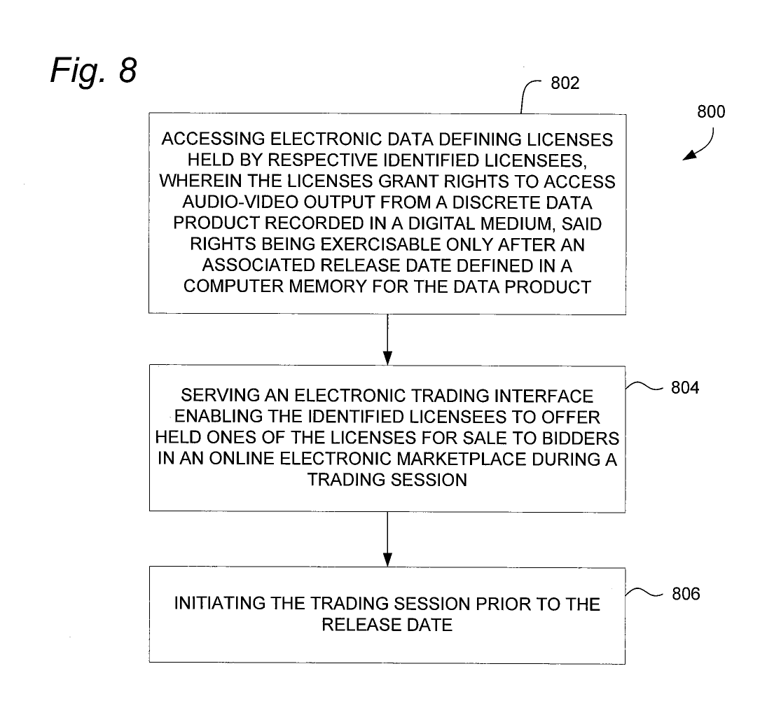

By way of an example summarizing aspects of the foregoing disclosure, a computer server or the like may serve an electronic trading interface and perform other operations, consistent with the foregoing methods and systems. The server may perform a method 800 as shown in FIG. 8. The method 800 may include accessing 802 electronic data defining licenses held by respective identified licensees, wherein the licenses grant rights to access audio-video output from a discrete data product recorded in a digital medium, said rights being exercisable only after an associated release date defined in a computer memory for the data product. Accessing may include reading, receiving, or otherwise obtaining the electronic data defining the licenses. Audio-video output may comprise the content that is the subject of the license, for example, a motion picture or other audio-visual production.

The electronic data should include, or be definitely associated with, information pertaining to license terms, including an identifier for the discrete data product, the licensee, and the relevant release date. The method 800 may further include serving 804 an electronic trading interface enabling the identified licensees to offer held ones of the licenses for sale to bidders in an online electronic marketplace during a trading session. Details concerning the electronic interface have been provided in the disclosure above, and are summarized in the discussion below. The method 800 may further include initiating 806 the trading session prior to the release date. Accordingly, persons participating in the trading session may trade the granted access rights prior to the release date of the content that is the subject of the license. A trade or pre-release acquisition of the access right does not change the applicable release date for the licensed content.

Method 800 may include further operations as described below. Method 800 may further include publishing current bid prices and ask prices for the held licenses offered for sale during the trading session, and registering a sale for a held license in response to determining that a bid price for the license matches an ask price.

The method may include causing the data product to be unplayable until the release date, for example, by using a Digital Rights Management (DRM) control method. However, in the alternative, DRM or other access control may be handled separately from trading. In one method, the data content is made available for download or other distribution prior to the release date, but requires a decryption key for access. The decryption key is not provided to the licensee until the release date. In the alternative, downloading or other distribution of the content may be restricted until the release date, with or without decryption keys.

The method may include determining a cumulative count of licenses granted for the data product prior to the release date, for any desired use. For example, the method 800 may include maintaining the cumulative count of licenses granted below a limit defined for the data product, by modulating licensing transactions during the trading session.

The method 800 may include granting the licenses defined by the electronic data, via an electronic interface. The electronic licensing interface may be linked to, or incorporated into, the electronic trading interface. In the alternative, the electronic licensing interface may be operated independently of the trading interface, for example, using a separate server. The method 800 may include controlling prices at which the licenses are granted in response to feedback indicating a current level of demand. The current demand level may be determined, for example, by measuring the current level of demand as a function of a rate of transactions completed per unit time. The method may include monitoring market liquidity during the trading session, and automatically generating a complementary selling bid or asking purchase offer on behalf of an administrative bidder in response to determining that market liquidity has dropped below a predetermined threshold.

The method 800 may include terminating the trading session for the data product at a time just prior to the release date. In the alternative, the trading session may be continued for a limited period after the release date. For example, the trading session may be controlled so that it is co-extensive with a licensed use period for the discrete data product. Trading sessions may be arranged in tranches for licenses having different release dates, as described above in connection with FIG. 5, and elsewhere. When trading is terminated at the release date, or prior to it, the method 800 may include electronically distributing the data product to all its current licensees as of the time that the trading session is terminated.

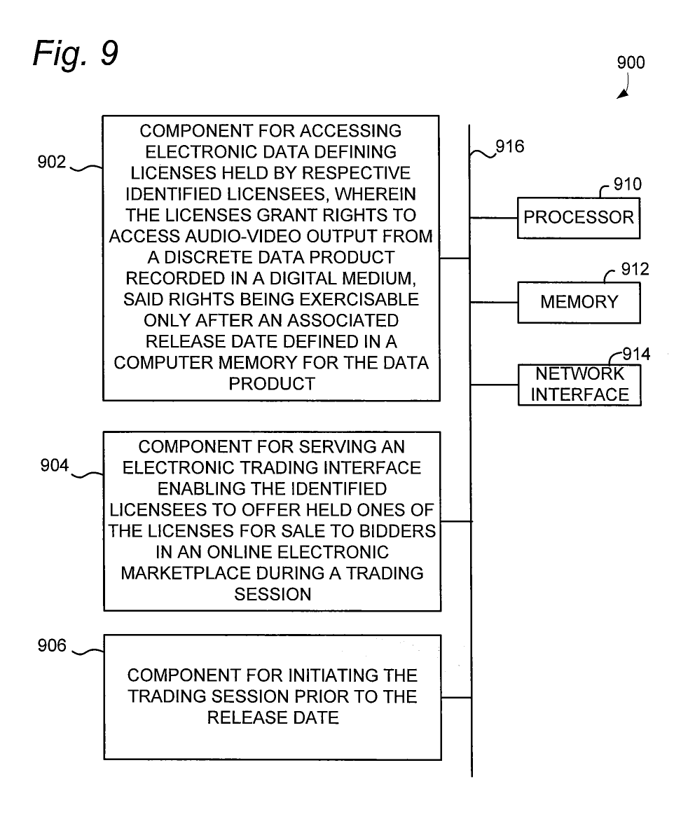

With reference to FIG. 9, there is provided an exemplary apparatus 900 that may be configured as a client, server, or standalone computer, or as a processor or similar device for use forgoing, for managing pre-release trading of a VOD or EST license. The apparatus 900 may include functional blocks that can represent functions implemented by a processor, software, or combination thereof (e.g., firmware).

As illustrated, in one embodiment, the apparatus 900 may include an electrical component or module 902 for accessing electronic data defining licenses held by respective identified licensees, wherein the licenses grant rights to access audio-video output from a discrete data product recorded in a digital medium, said rights being exercisable only after an associated release date defined in a computer memory for the data product. For example, the electrical component 902 may include at least one control processor coupled to a user interface or the like and to a memory with instructions for accessing a database of licenses. The apparatus 900 may include an electrical component 904 for serving an electronic trading interface enabling the identified licensees to offer held ones of the licenses for sale to bidders in an online electronic marketplace during a trading session. For example, the electrical component 904 may include at least one control processor coupled to a memory holding instructions for serving the electronic trading interface while using license information organized by release date. The apparatus 900 may include an electrical component 906 for initiating the trading session prior to the release date. For example, the electrical component 906 may include at least one control processor coupled to a clock and to a memory holding instructions for initiating the trading session a defined period in advance of the release date. The apparatus 900 may include similar electrical components for performing any or all of the additional operations described in connection with FIG. 8, which for illustrative simplicity are not shown in FIG. 9.

In related aspects, the apparatus 900 may optionally include a processor component 910 having at least one processor, in the case of the apparatus 900 configured as a client, server, or standalone computer. The processor 910, in such case, may be in operative communication with the components 902-906 or similar components via a bus 916 or similar communication coupling. The processor 910 may effect initiation and scheduling of the processes or functions performed by electrical components 902-906.

In further related aspects, the apparatus 900 may include a network interface or other data transfer component 914. A receiver or media reader may be used in lieu of or in conjunction with the network interface 914. The apparatus 900 may optionally include a component for storing information, such as, for example, a memory device/component 912. The computer readable medium or the memory component 912 may be operatively coupled to the other components of the apparatus 900 via the bus 916 or the like. The memory component 912 may be adapted to store computer readable instructions and data for performing the activity of the components 902-906, and subcomponents thereof, or the processor 910, the additional operations, or the methods disclosed herein. The memory component 912 may retain instructions for executing functions associated with the components 902-906. While shown as being external to the memory 912, it is to be understood that the components 902-906 can exist within the memory 912.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection may be properly termed a computer-readable medium to the extent involving non-transient storage of transmitted signals. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Having thus described embodiments of the trading and distribution system for audio-video content, and method of use, it should be apparent to those skilled in the art that certain advantages of the within system have been achieved. It should also be appreciated that various modifications, adaptations, and alternative embodiments thereof may be made without departing from the scope and spirit of the present technology. For example, a trading system for electronically distributed audio-video content has been illustrated, but it should be apparent that the novel concepts described above may be adapted by one of ordinary skill to audio-video content distributed in other media or electronic formats to thereby realize the unexpected benefits described herein.

What is claimed is:

1. A method, comprising:
accessing electronic data defining licenses held by respective identified licensees, wherein the licenses grant rights to access audio-video output from a discrete data product recorded in a digital medium, said rights being exercisable only after an associated release date defined in a computer memory for the data product;
serving an electronic trading interface enabling the identified licensees to offer held ones of the licenses for sale to bidders in an online electronic marketplace during a trading session; and
initiating the trading session prior to the release date.

2. The method of claim 1, further comprising publishing current bid prices and ask prices for the held licenses offered for sale during the trading session.

3. The method of claim 1, further comprising registering a sale for a held license in response to determining that a bid price for the license matches an ask price.

4. The method of claim 1, further comprising causing the data product to be unplayable until the release date.

5. The method of claim 1, further comprising determining a cumulative count of licenses granted for the data product prior to the release date.

6. The method of claim 5, further comprising maintaining the cumulative count of licenses granted below a limit defined for the data product, by modulating licensing transactions during the trading session.

7. The method of claim 1, further comprising granting the licenses defined by the electronic data, via an electronic interface.

8. The method of claim 7, further comprising controlling prices at which the licenses are granted in response to feedback indicating a current level of demand.

9. The method of claim 8, further comprising measuring the current level of demand as a function of a rate of transactions completed per unit time.

10. The method of claim 1, further comprising terminating the trading session for the data product at a time just prior to the release date.

11. The method of claim 10, further comprising electronically distributing the data product to all its current licensees as of the time that the trading session is terminated.

12. The method of claim 1, further comprising controlling the trading session so that it is co-extensive with a licensed use period for the discrete data product.

13. The method of claim 1, further comprising monitoring market liquidity during the trading session, and automatically generating a complementary selling bid or asking purchase offer on behalf of an administrative bidder in response to determining that market liquidity has dropped below a predetermined threshold.

14. An apparatus for managing transfer of licenses granting rights to access audio-video output from a discrete data product recorded in a digital medium, wherein said rights are exercisable only after an associated release date for the data product, the apparatus comprising:
at least one processor configured for accessing electronic data defining the licenses held by respective identified licensees, serving an electronic trading interface enabling the identified licensees to offer held ones of the licenses for sale to bidders in an online electronic marketplace during a trading session, and initiating the trading session prior to the release date; and
a memory coupled to the at least one processor for storing data.

15. The apparatus of claim 14, wherein the at least one processor is further configured for publishing current bid prices and ask prices for the held licenses offered for sale during the trading session.

16. The apparatus of claim 14, wherein the at least one processor is further configured for causing the data product to be unplayable until the release date.

17. The apparatus of claim 14, wherein the at least one processor is further configured for determining a cumulative count of licenses granted for the data product prior to the release date.

18. The apparatus of claim 17, wherein the at least one processor is further configured for maintaining the cumulative count of licenses granted below a limit defined for the data product, by modulating licensing transactions during the trading session.

19. The apparatus of claim 14, wherein the at least one processor is further configured for granting the licenses defined by the electronic data, via an electronic interface.

20. The apparatus of claim 19, wherein the at least one processor is further configured for controlling prices at which the licenses are granted in response to feedback indicating a current level of demand.

21. The apparatus of claim 20, wherein the at least one processor is further configured for measuring the current level of demand as a function of a rate of transactions completed per unit time.

22. The apparatus of claim 14, wherein the at least one processor is further configured for terminating the trading session for the data product at a time just prior to the release date.

23. The apparatus of claim 22, wherein the at least one processor is further configured for electronically distributing the data product to all its current licensees as of the time that the trading session is terminated.

24. A computer program product for managing transfer of licenses granting rights to access audio-video output from a discrete data product recorded in a digital medium, wherein said rights are exercisable only after an associated release date for the data product, the product comprising:
A computer-readable medium holding code for accessing electronic data defining the licenses held by respective identified licensees, serving an electronic trading interface enabling the identified licensees to offer held ones of the licenses for sale to bidders in an online electronic marketplace during a trading session, and initiating the trading session prior to the release date.

25. The computer program product of claim 24, holding further code for publishing current bid prices and ask prices for the held licenses offered for sale during the trading session.

26. The computer program product of claim 24, holding further code for causing the data product to be unplayable until the release date.

27. The computer program product of claim 24, holding further code for determining a cumulative count of licenses granted for the data product prior to the release date.

28. The computer program product of claim 27, holding further code for maintaining the cumulative count of licenses granted below a limit defined for the data product, by modulating licensing transactions during the trading session.

29. The computer program product of claim 24, holding further code for granting the licenses defined by the electronic data, via an electronic interface.

30. The computer program product of claim 29, holding further code for controlling prices at which the licenses are granted in response to feedback indicating a current level of demand.

31. The computer program product of claim 24, holding further code for terminating the trading session for the data product at a time just prior to the release date.

32. The computer program product of claim 24, holding further code for electronically distributing the data product to all its current licensees as of the time that the trading session is terminated.
